(19) United States
(12) Patent Application Publication
(10) Pub. No.: US 2005/0275712 A1
(43) Pub. Date: Dec. 15, 2005

(54) Image recording apparatus

(75) Inventor: Tatsuya Konagaya, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/151,256

(22) Filed: Jun. 14, 2005

(30) Foreign Application Priority Data
Jun. 15, 2004 (JP) 2004-177312

(51) Int. Cl. B41J 2/435; B41J 13/00

(52) U.S. Cl. 347/237; 347/262

(57) ABSTRACT

A passage switching section of an image recording apparatus is provided with a main outlet formed for discharging a normal-sized recording-paper sheet carried along a main passage. A sub-outlet is formed above the main outlet. A sub-passage diverges from the main passage toward the sub-outlet. A passage switching mechanism for changing the sheet passage is disposed at a bifurcation of the passages. A density measuring sensor is disposed at the sub-passage. On the basis of varied sheet information including sheet-size information, a calibration sheet for calibrating recording density of an exposing section is discharged from the sub-outlet. At this time, density of a calibration pattern of the calibration sheet is measured. It is possible to calibrate the recording density of the image recording apparatus in an unmanned state.

### BACKGROUND OF THE INVENTION

1. Field of the Invention

The present invention relates to an image recording apparatus for recording an image on a sheet-shaped recording material.

2. Description of the Related Art

An image recording apparatus (printer processor) for producing a photographic print is widely used. In this kind of the image recording apparatus, a photosensitive recording paper (recording material) is exposed through an image with recording light of which intensity is modulated on the basis of digital image data, which is obtained by photoelectrically scanning an image recorded on a photographic film. Alternatively, the intensity of the recording light is modulated on the basis of image data recorded in a recording medium of a memory card and so forth. After exposing the photosensitive recording paper, processes of developing, washing and drying are performed therefor.

As to the above-described image recording apparatus, if a sort of the photosensitive recording paper is different and surrounding conditions are different, recording density of the photosensitive recording paper fluctuates, and it is prevented that a proper photographic print is obtained. In view of this, such as described in Japanese Patent Laid-Open Publication No. 2000-241893, for instance, a calibration pattern is recorded (by exposure) for correcting (calibrating) the recording density, and in addition, a calibration sheet (also called a patch sheet) is made in advance. On the calibration sheet, are recorded information and so forth concerning a sort of the photosensitive recording paper on which the pattern is recorded, and concerning surroundings in the time of recording the pattern. Further, a density measuring unit is disposed at a main passage extending from a magazine containing the photosensitive recording paper to an outlet from which the photographic print is discharged. The density measuring unit is capable of reading varied information while measuring the density of the calibration pattern.

An operator regularly sets the calibration sheet to the density measuring unit and handles an operation panel to measure the density of the calibration pattern and to read the information. A difference between the measured density of the calibration pattern and the known reference density thereof stored in advance is calculated so that it is possible to calibrate the recording density of an exposing unit. At this time, from the read sort information, it is possible to check the sorts of the calibration sheet with the photosensitive recording paper set in the magazine. Further, from the read information concerning the surroundings, it is possible to correct differences between the surroundings in the calibration-sheet producing time and the surroundings in the calibration time. Thus, it is possible to accurately perform the calibration. As a result, the photographic print having a proper density is obtained.

Usually, the used calibration sheet is carried from the density measuring unit toward the outlet as it is. And then, the calibration sheet is discharged onto a tray disposed near the outlet. On the tray, however, the photographic prints being as products are stacked. Thus, when the calibration is performed, the operator is required to remove the calibration sheet from the tray so as not to interpose the calibration sheet between the photographic prints. This operation is troublesome.

Meanwhile, in a case the image recording apparatus is placed in a photo studio or the like, a clerk (operator) removes the calibration sheet when the calibration is performed. In recent years, however, a printer processor is placed in a convenience store, a department store and a station so as to be capable of easily producing a photographic print of an image taken by a camera-equipped cell-phone and an electronic camera. In this case, since exclusive clerk and operator for managing the image recording apparatus do not exist, it is required that a service person or the like performs the calibration periodically. Thus, maintenance cost becomes high. Therefore, it is strongly desired to create the image recording apparatus in which the calibration is automatically performed.

### SUMMARY OF THE INVENTION

In view of the foregoing, it is a primary object of the present invention to provide an image recording apparatus in which it is needless to perform an operation for removing an unnecessary recording material of a calibration sheet and so forth.

It is a second object of the present invention to provide an image recording apparatus in which calibration is automatically performed.

In order to achieve the above and other objects, the image recording apparatus according to the present invention comprises an image recorder, a magazine, a discharger and a main passage. The image recorder records an image on a sheet-shaped recording material. The magazine contains the recording material and feeds it to the image recorder. The discharger ejects the recording material to be dealt with as a product on which the image has been recorded. The main passage extends from the magazine toward a main outlet formed at the discharger. The image recording apparatus further comprises a sub-passage, a passage switching mechanism and a changeover controller. The sub-passage deviates from the main passage toward a sub-outlet for discharging the unnecessary recording material, which is not dealt with as the product. The passage switching mechanism is disposed at a bifurcation of the sub-passage and the main passage to change first and second states. In the first state, the recording material is carried along the main passage. In the second state, the recoding material is carried along the sub-passage. The changeover controller judges whether the recording material is necessary or not. On the basis of this judgement result, the changeover controller changes the first state of the passage switching mechanism to the second state.

It is preferable that the normal-sized recording material and the large-sized recording material are fed to the image recorder from the magazines. The changeover controller judges whether the recording material is the large size or not. On the basis of this judgement result, the first state of the passage switching mechanism is changed to the second state when the large-sized recording material just passes the bifurcation. Moreover, it is preferable that an accumulation member is placed at a downstream side of the sub-passage in a carrying direction to accumulate the unnecessary recording material.

It is preferable that the image recording apparatus further comprises a density measuring unit and a calibration controller. The density measuring unit is disposed at the sub-passage to measure a density of the image recorded on the recording material. The calibration controller feeds the recording material from the magazine to the image recorder to record a calibration pattern, which is used for calibrating a recording density of the image recorder, on the recording material. The calibration controller calculates a difference between a measurement density of the calibration pattern, which is measured by the density measuring unit, and a known reference density. On the basis of the calculation result of the difference, the calibration controller calibrates the recording density of the image recorder. The unnecessary recording material is preferable to be the recording material on which the calibration pattern is recorded.

Moreover, it is preferable to provide an automatic mode for automatically commencing the calibration, and a manual mode for manually commencing the calibration. The calibration controller commences the calibration of the recording density under the automatic mode on satisfying at least one of conditions that the magazine has just been loaded in the apparatus, that an electric source of the apparatus has just been turned on, and that a predetermined hour has arrived. Further, it is preferable that the magazine is provided with a record member storing identification information of the magazine including sort information of the recording material. In this case, a reader for reading the identification information stored in the record member is provided in the apparatus. If the identification information read by the reader is same with that of the previously loaded magazine under the automatic mode, the calibration controller avoids performing the calibration of the recording density.

Further, it is preferable that the magazine contains a recording-paper roll in which joined recording papers are taken up in a roll form. In addition, it is preferable that the magazine is provided with a cutter for cutting the recording paper, which is drawn out of the recording-paper roll, into a predetermined length. A joint portion of the recording papers and a leading portion thereof, which are cut by the cutter, are regarded as the unnecessary recording material.

According to the image recording apparatus of the present invention, it is possible to prevent the unnecessary recording material from being interposed between the recording materials to be treated as the products. Therefore, there is no need for an operator to remove the unnecessary recording material.

Moreover, since the image recording apparatus of the present invention carries the large-sized recording material along the sub-passage, it is possible to separately accumulate the normal-sized recording material and the large-sized recording material.

In the image recording apparatus of the present invention, the density measuring unit for measuring the density of the image recorded on the recording material is disposed at the sub-passage. The recording material on which the calibration pattern is recorded is carried along the sub-passage to calibrate the recording density. Thus, it is prevented that the recording material of the calibration pattern is interposed between the recording materials to be treated as the products. In virtue of this, the recording density of the image reader is automatically calibrated in an unmanned state.

In the image recording apparatus, the calibration of the recording density is automatically performed when the magazine is just loaded, when the electric source of the apparatus is just turned on, or when the predetermined hour just arrives. Thus, there is no need for the operator to regularly perform the calibration. It is possible to place the apparatus without problems in places of a convenience store, a department store, a station and so forth where an exclusive manager of the apparatus does not exist.

The image recording apparatus avoids performing the calibration of the recording density when the sort of the newly lorded magazine is same with that of the previously loaded magazine. Thus, performing the unnecessary calibration is prevented.

The joint portion of the recording material and the leading portion thereof are discharged from the sub-outlet as the unnecessary recording material. Thus, it is possible to save a labor of the operator to be taken for removing the unnecessary recording material.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing an image recording apparatus according to the present invention;

FIG. 2 is a schematic illustration showing a passage switching section of the image recording apparatus;

FIG. 3 is a schematic illustration showing a calibration sheet produced at a time of recoding-density calibration of an exposing section of the image recording apparatus;

FIG. 4 is a block diagram showing a controller of the image recording apparatus;

FIG. 5 is a flowchart showing a sequence, which is executed when the recording-density calibration of the exposing section is commenced;

FIG. 6 is a flowchart showing a sequence for executing the recording-density calibration of the exposing section;

FIG. 7 is a flowchart showing a sequence, which is executed when the calibration is commenced upon turning on an electric source of the image recording apparatus; and

FIG. 8 is a flowchart showing a sequence, which is executed when the calibration is commenced at a preset hour.

### DETAILED DESCRIPTION OF THE PREFERRED EMBODIMENT(S)

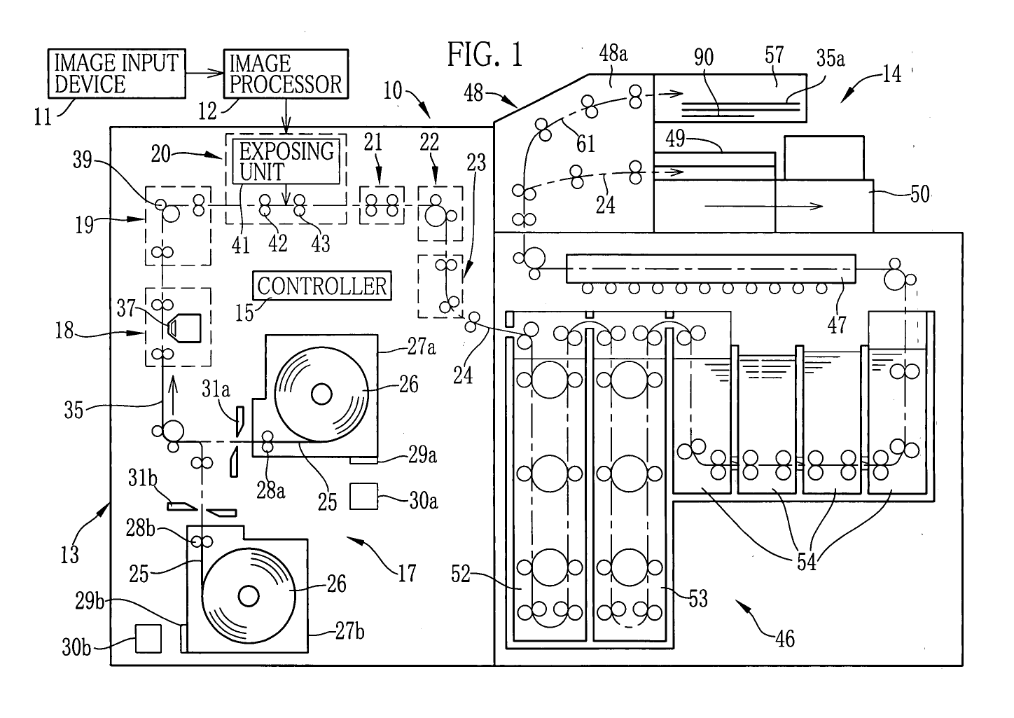

FIG. 1 shows a schematic illustration of an image recording apparatus 10 according to the present invention. Such as shown in FIG. 1, the image recording apparatus 10 is mainly constituted of an image input device 11, an image processor 12, a printer 13, a processor 14 and so forth. Each component constituting the image recording apparatus 10 is connected to a controller 15 via wiring not shown. The controller 15 controls the entire operation of the image recording apparatus 10.

The image input device 11 produces image data by photoelectrically reading projection light of an image, which is recorded on a photographic film, with an imaging device of a CCD image sensor and so forth. Alternatively, the image input device 11 reads the image data recorded in a recording medium of a memory card and so forth to obtain this data. The image data is transferred to the image processor 12 to perform image processing of color-balance correction, density collection and so forth. The image data for which the image processing has been performed is transferred to the printer 13.

The printer 13 records an image while feeding a photosensitive recording paper (recording material) of a cut-sheet shape in a sub-scanning direction (feed direction). The printer 13 is constituted of a feeding section 17, a back-printing section 18, a skew-correcting section 19, an exposing section (image recorder) 20, a receiving section 21, a sorting section 22, a discharging section 23 and so forth. These sections are provided with carrying roller pairs constituted of drive rollers and nip rollers. The carrying roller pairs are disposed along a main passage 24 (shown by a dashed line in the drawing) of the photosensitive recording paper.

Magazines 27a and 27b are set in the feeding section 17. The respective magazines 27a and 27b contain a recording-paper roll 26 in which the photosensitive recording paper 25 is taken up in a roll form. Feed roller pairs 28a and 28b are disposed in the respective magazines 27a and 27b to draw the photosensitive recording paper 25 and to carry it toward the back-printing section 18. Although the two magazines 27a and 27b are provided in this embodiment, the sole magazine may be provided and three or more magazines may be provided. Further, the two magazines 27a and 27b may contain the photosensitive recording papers 25 having different breadth and thickness. Meanwhile, as to the recording paper 25 contained in the respective magazines 27a and 27b, it is usual that edge portions of the strip-shaped recording papers 25 are joined to each other. At a joint portion (not shown) of the recording papers 25, a splice hole (not shown) is formed to represent the joint portion.

The magazines 27a and 27b are provided with bar codes 29a and 29b recording magazine ID information, which includes sort information concerning thickness, material and so forth of the photosensitive recording paper 25 (recording-paper roll 26). The feeding section 17 is provided with bar-cord readers 30a and 30b disposed at positions confronting the bar codes 29a and 29b of the magazines 27a and 27b set at predetermined positions. The magazine ID information read by the respective bar-code readers 30a and 30b is sent to the controller 15.

When the feed roller pairs 28a and 28b are rotated by a motor not shown, the photosensitive recording papers 25 are drawn out of the recording-paper rollers 26 and are carried toward cutters 31a and 31b, which are actuated upon reception of a control signal outputted from the controller 15. The cutter cuts the recording paper 25 drawn by a predetermined length in accordance with a print size to produce a recording-paper sheet 35. By the way, instead of providing two cutters, the sole cutter may be disposed near the back-printing section 18.

In this embodiment, the recording-paper sheets 35 are carried in a single row until the sorting section 22, and timing of the recording-paper sheets 35 to be fed from the respective magazines 27a and 27b is automatically adjusted. In a case that kinds of the recording papers 25 contained in the magazines 27a and 27b are same, feeding the recording paper 25 from one of the magazines may be commenced after feeding of the other magazine has been completed. The recording-paper sheets 35 cut by the cutters 31a and 31b are carried along the main passage 24 by the carrying roller pairs disposed along the passage. The recording-paper sheets 35 are carried to the back-printing section 18, the skew-correcting section 19, the exposing section 20, the receiving section 21, the sorting section 22 and the discharging section 23 in this order.

The back-printing section 18 comprises a back-printing head 37 for recording print information, which concerns a shooting date, a print date, a frame number, various IDs and so forth, on a rear surface of the recording-paper sheet 35 (opposite surface to a recording surface). As to the back-printing head 37, it is possible to employ well-known print heads of a dot-impact head, an ink-jet head, a thermal-transfer print head and so forth.

The skew-correcting section 19 includes a resist roller pair 39 and carrying roller pairs to prevent an angle and a position of exposure from deviating in the exposing section 20. The resist roller pair 39 corrects a skew of the recording-paper sheet 35. The carrying roller pairs are disposed in front of and behind the resist roller pair 39. Regarding a method for correcting the skew by the resist roller pair 39, it is possible to adopt a well-known method. For instance, it is possible to adopt the methods described in Japanese Patent Laid-Open Publication Nos. 60-153358 and 11-349191.

The exposing section 20 includes an exposing unit 41 and feed roller pairs 42 and 43. The exposing unit 41 comprises a well-known laser printer and an image memory, although illustration thereof is omitted. The image memory stores the image data transferred from the image processor 12. The laser printer applies recording light (laser beam) in a scanning direction perpendicular to the sub-scanning direction to record an image on the recording-paper sheet 35. Intensity of the recording light is modulated in accordance with the image to be recorded. A nip roller of the respective feed roller pairs 42 and 43 is changeable between a nip position nipping the recording-paper sheet 35 and a nip releasing position separating therefrom. These positions are switched when a positional sensor not shown has detected an anterior end of the recording-paper sheet 35 or a posterior end thereof. In virtue of this, a feed speed of the recording-paper sheet 35 is prevented from fluctuating during the exposure.

The receiving section 21 comprises a plurality of roller pairs for holding the anterior end of the recording-paper sheet 35 advanced from the exposing unit 20 during the exposure. The receiving section 21 forwards the recording-paper sheet 35 to a downstream side in the carrying direction at an identical speed with a feeding speed of the exposure section 20. The respective roller pairs of the receiving section 21 include a drive roller and a nip roller, which is capable of releasing a nip. The recording-paper sheet 35 is not nipped during the exposure recording. When the exposure recording has been completed for the posterior end, the nip roller moves to a nipping position to nip the recording-paper sheet 35 and to carry it toward the sorting section 22.

The sorting section 22 carries the recording-paper sheets 35 of a single row at a predetermined first speed. During this carry, the sorting section 22 sorts the recording-paper sheets 35 into plural rows in accordance with a sheet size. For example, when the recording-paper sheets 35 having a normal size or a small size are carried, the sorting section 22 sorts these sheets into two rows. When the recording-paper sheets 35 having a large size are carried, it is impossible to carry these sheets 35 in two rows. In this case, the sheets 35 are carried in a single row without sorting. Incidentally, the recording-paper sheets 35 may be sorted into three or more rows depending on a width of the main passage 24. The sorting section 22 is exchangeable and the one having ability corresponding to a processing speed of the image recording apparatus 10 is detachably set. Meanwhile, the discharging section 23 carries the recording-paper sheet 35, which has been forwarded from the sorting section 22, to the processor 14 at a second speed corresponding to a processing speed of the processor 14.

The processor 14 is constituted of a processing section 46, a drying section 47, a passage switching section 48, a rearranging section 49, a sorter 50 and so forth. The recording-paper sheet 35 discharged from the printer 13 is carried in the processor 14 along a passage shown by a dashed line in FIG. 1. The processing section 46 includes a developing bath 52, a bleaching/fixing bath 53 and washing baths 54 arranged in this order from an upstream side of the processing section 46. The developing bath 52, the bleaching/fixing bath 53 and the washing baths 54 contain developing solution, bleaching/fixing solution and washing water respectively by a predetermined amount. The recording-paper sheet 35 is developed, fixed and washed while carried through the respective baths 52 to 54 in order.

The drying section 47 is disposed above the respective baths 52 to 54, and is constituted of a conveyor belt and a blower duct which are not shown. The blower duct blows dry air heated by a heater (not shown) to the recording-paper sheet 35 carried on the conveyor belt. In virtue of this, the washing water existing on the recording-paper sheet 35 having been washed in the washing bath 54 is removed. The dried recording-paper sheet (photographic print) 35 is carried to the passage switching section 48 disposed above an outlet of the drying section 47.

The present invention is applied to the passage switching section 48. As will be described later in detail, the recording-paper sheets 35 of the normal size are carried to the rearranging section 49 in two rows, and when the recording-paper sheet 35a of the large size is carried, the passage is changed to carry this sheet to an accumulation box 57 attached to a downstream side of a sub-passage 61. When a defective sheet other than the photographic print is carried, the passage is also changed to carry the defective sheet to the accumulation box 57.

The rearranging section 49 rearranges the recording-paper sheets 35, which have the normal size and are carried in two rows, to carry these sheets in one row. The rearranging section 49 has rearranging ability corresponding to processing ability of the image recording apparatus 10 (for example, the rearranging section 49 has a high rearranging speed or carries the sheets without rearrangement). The rearranging section 49 is set in an exchangeable manner. The sorter 50 outputs the recording-paper sheets 35, which have been forwarded from the rearranging section 49, in a lump every print job.

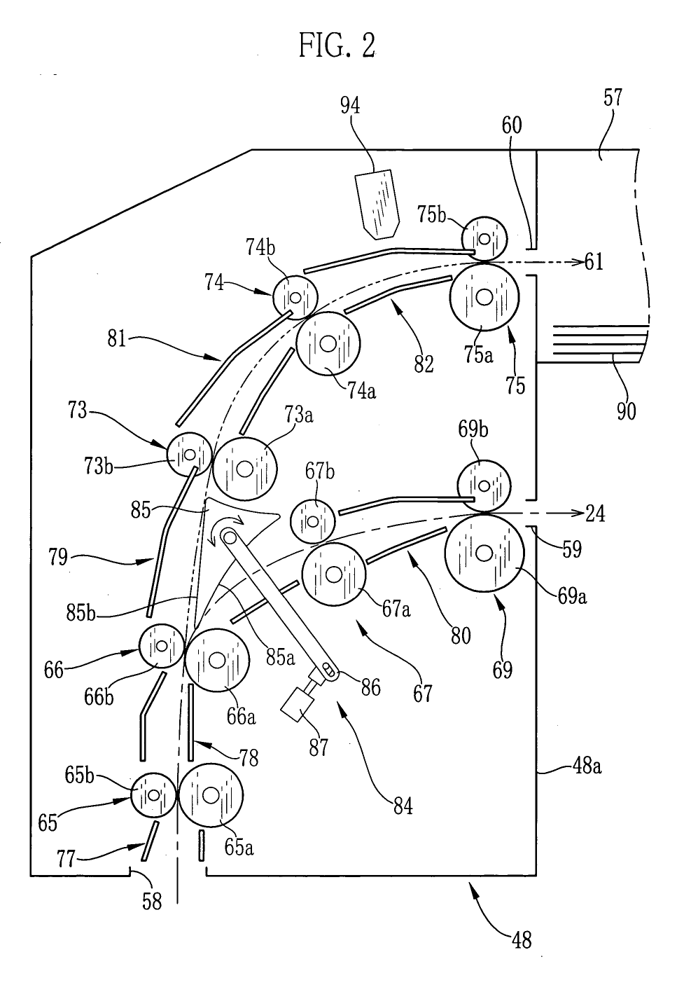

Next, the passage switching section 48 is described below with FIG. 2. As shown in FIG. 2, an inlet 58 is formed at the bottom of a body 48a of the passage switching section 48 to receive the recording-paper sheet 35 forwarded from the drying section 47. A main outlet 59 is formed at a right side of the body 48a in the drawing to discharge the recording-paper sheet 35, which has the normal size and is carried along the main passage 24, to the rearranging section 49. Moreover, above the main outlet 59, a sub-outlet 60 is formed to discharge the large-sized recording-paper sheet 35a (see FIG. 1) and so forth to the accumulation box 57. Further, the sub-passage 61 is formed in the body 48a so as to diverge from the main passage 24, along which the normal-sized recording-paper sheet 35 is carried, toward the sub-outlet 60.

Between the inlet 58 and the main outlet 59, first to third carrying roller pairs 65 to 67 and a high-speed discharging roller pair 69 are disposed along the main passage 24 in order from the upstream side. The main passage 24 extends from the inlet 58 vertically and upwardly, and curves so as to horizontally extend near the main outlet 59. The respective roller pairs 65 to 67 and 69 are arranged along the curved main passage 24. The first to third carrying roller pairs 65 to 67 include first to third capstan rollers 65a to 67a to be rotated by a motor not shown, and first to third nip rollers 65b to 67b being as driven rollers. The capstan rollers 65a to 67a and the nip rollers 65b to 67b are disposed so as to interpose the main passage 24 between them.

Although illustration is omitted, a belt is put on the first to third capstan rollers 65a to 67a to rotate these rollers at an identical peripheral velocity. Meanwhile, the high-speed discharging roller pair 69 includes a high-speed drive roller 69a and a high-speed nip roller 69b. The high-speed drive roller 69a is capable of rotating faster than the first to third capstan rollers 65a to 67a so that it is possible to shorten a time taken for forwarding the recording-paper sheet 35 to the rearranging section 49. Incidentally, the high-speed drive roller 69a is rotated at the same speed with the first to third capstan rollers 65a to 67a until the posterior end of the recording-paper sheet 35 is sent out of the third carrying roller pair 67.

In this embodiment, the sub-passage 61 diverges from a downstream side of the second carrying roller pair 66 in the carrying direction toward the sub-outlet 60. Between the bifurcation and the sub-outlet 60, fourth to sixth carrying roller pairs 73 to 75 are disposed. The sub-passage 61 also curves so as to horizontally extend near the sub-outlet 60, similarly to the main passage 24. The fourth to sixth carrying roller pairs 73 to 75 are disposed along the curved sub-passage 61. Incidentally, the fourth to sixth carrying roller pairs 73 to 75 are substantially identical with the first to third carrying roller pairs 65 to 67, and are constituted of fourth to sixth capstan rollers 73a to 75a and fourth to sixth nip rollers 73b to 75b, which are disposed so as to interpose the sub-passage 61 between them.

First to sixth carrying guides 77 to 82 are respectively disposed between the inlet 58, the first to third carrying roller pairs 65 to 67, the high-speed discharging roller pair 69, and the fourth to sixth carrying roller pairs 73 to 75 to guide the anterior end of the recording-paper sheet 35, which is sent from the respective upstream carrying roller pairs, toward the downstream carrying roller pair. The first to sixth carrying guides 77 to 82 may be formed from any material of metal, plastic and so forth.

The bifurcation of the main passage 24 and the sub-passage 61 is provided with a passage switching mechanism 84. For example, the passage switching mechanism 84 is constituted of a changing guide 85, an arm 86 whose one end is fixed to the changing guide 85, and a solenoid connected to the other end of the arm 86. The changing guide 85 is made of plastic material, and is formed so as to have a first guide surface 85a and a second guide surface 85b. The first guide surface 85a guides the normal-sized recording-paper sheet 35 to the third carrying roller pair 67. The second guide surface 85b guides the large-sized recording-paper sheet 35a (see FIG. 1) to the fourth carrying roller pair 73. Drive of the solenoid 87 is controlled by the above-mentioned controller 15 (see FIG. 1). The solenoid 87 is activated by the controller 15 to rotate the changing guide 85 so that the passage of the sheet is changed to either of the main passage 24 and the sub-passage 61.

In this way, the sub-passage 61 diverges from the middle of the main passage 24, and the sheet passage is adapted to be switched to either of the main passage 24 and the sub-passage 61. In this embodiment, besides the large-sized recording-paper sheet 35a, a calibration sheet 90 is discharged from the sub-outlet 60. The calibration sheet 90 is used for calibrating a density of recording to be performed on the recording-paper sheet 35 by the exposing section 20. By discharging the calibration sheet 90 from the sub-outlet 60, it is prevented to interpose the calibration sheet 90 between the photographic prints. Further, in this embodiment, the calibration is automatically commenced so that it is unnecessary for an operator (clerk) and others to manually commence the calibration. In a concrete manner, the calibration is commenced when there is a possibility of changing a kind of the recording-paper sheet 35, namely when the new magazines 27a and 27b have just been set (loaded) in the printer 13.

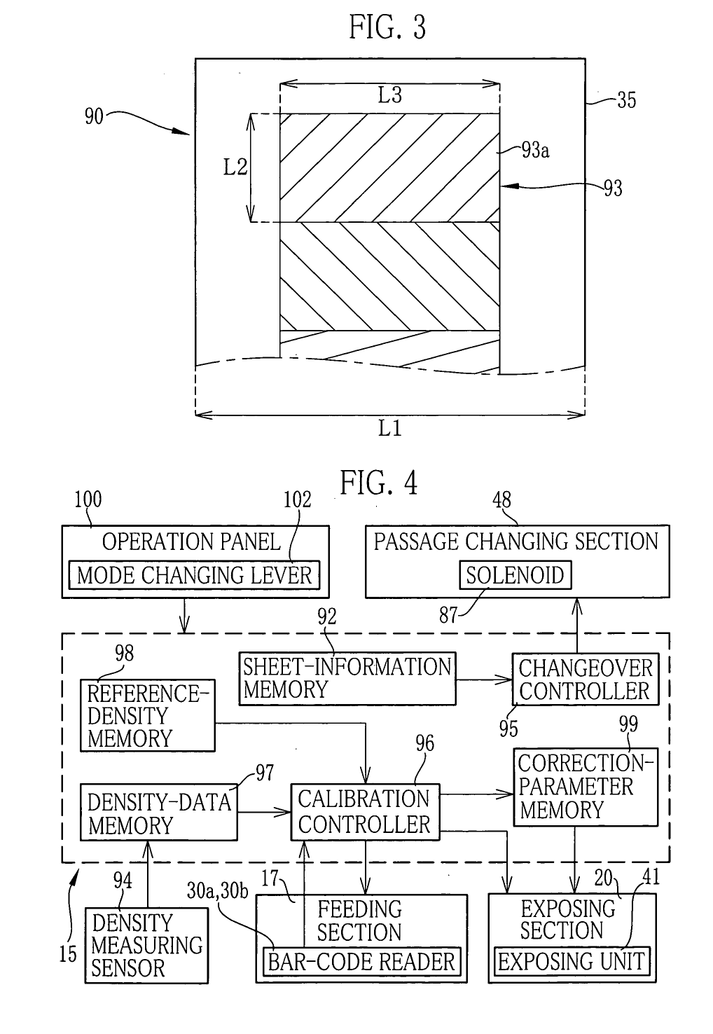

In order to perform the calibration, a density measuring sensor 94 is disposed between the fifth and sixth carrying roller pairs 74 and 75 of the sub-passage 61. The density measuring sensor 94 measures a density of a calibration pattern 93 (see FIG. 3) recorded on the calibration sheet 90. Incidentally, the carrying guide 82 confronting the density measuring sensor 94 is formed so as to have an opening (not shown) for measuring the density.

As shown in FIG. 3, the calibration sheet 90 is the recording-paper sheet 35 on which the predetermined calibration pattern 93 is recorded in the exposing section 20 and for which processes of developing, fixing, washing and drying are performed. The calibration sheet 90 is formed at the time of calibration. A color, a form and so forth of the calibration pattern 93 are not limited. In this embodiment, colors of cyan, magenta, yellow, gray and so forth are recorded on the recording-paper sheet 35 as the calibration pattern 93 such that the respective colors are divided into rectangular density patterns 93a from high density to low density. Further, the respective density patterns 93a are formed so as to be easily detected by the density measuring sensor 94 in a state that one side thereof in a width direction of the recording-paper sheet 35 is longer than the other side. For instance, in this embodiment, the respective density patterns 93a are formed such that a length L2 in the carrying direction is 29 mm and a length L3 in the width direction of the recording-paper sheet 35 is 50 mm.

The carried sheet already turns out to be the large-sized recording-paper sheet 35a or the calibration sheet 90 at the point that the recording-paper sheet has been produced by cutting the photosensitive recording paper 25 drown out of the recording-paper roll 26 of the respective magazines 27a and 27b. Accordingly, by tracking the position of the sheet on the basis of information concerning the sheet cut by the respective cutters 31a, 31b and forwarded onto the main passage 24, it is easily judged that the sheet carried toward the changing guide 85 is the normal-sized recording-paper sheet 35, the large-sized recording-paper sheet 35a or the calibration sheet 90.

In this embodiment, for the purpose of preventing the calibration sheet 90 from being interposed between the photographic prints, the normal-sized recording-paper sheet 35 and the calibration sheet 90 are not carried side by side on the main passage 24. In other words, when the large-sized recording-paper sheet 35a and the recording-paper sheet 35 on which the calibration pattern 93 is recorded are carried, the sorting section 22 (see FIG. 1) carries them in a single row without sorting. By the way, in a case that the normal-sized recording-paper sheet 35 and the calibration sheet 90 are carried side by side, the passage switching mechanism 84 of the passage switching section 48 is provided for the respective rows.

As to the density measuring sensor 94 shown in FIG. 2, any sensor may be used. In this embodiment, a color CCD image sensor is used, for example. In order to surely obtain the image of the calibration pattern 93, it is preferable to form the density measuring sensor 94 such that a length thereof in the sheet-width direction is longer than a breadth of the main passage 24. A detection (image) signal from the density measuring sensor 94 is converted into image data by an A/D converter and an image processor, which are not shown. And then, the converted image data is transferred to the controller 15.

FIG. 4 is a functional block diagram of the controller 15. As shown in FIG. 4, the controller 15 comprises a sheet-information memory 92, a changeover controller 95, a calibration controller 96, a density-data memory 97, a reference-density memory 98, a correction-parameter memory 99 and so forth. In the meantime, an operation panel 100 for performing operation and setting of the printer processor 10 is connected to the controller 15 besides the feeding section 17, the exposing section 20, the passage switching section 48 and the density measuring sensor 94. Incidentally, such as described above, the other sections of the image recording apparatus 10 are connected to the controller 15 in addition to the sections shown in FIG. 4. The controller 15 is provided with control units for controlling these sections.

The sheet-information memory 92 stores varied sheet information including sheet-size information of the normal-sized recording-paper sheet 35, the large-sized recording-paper sheet 35a, and the calibration sheet 90. The sheet-size information is sent from a superior computer (not shown). On the basis of the sheet information stored in the sheet-information memory 92, it is possible to distinguish the kind of the recording-paper sheet cut by the respective cutters 31a and 31b, and advanced onto the main passage 24.

On the basis of the sheet information stored in the sheet-information memory 92, the changeover controller 95 distinguishes whether the sheet forwarded from the feeding section 17 is the normal-sized recording-paper sheet 35, the large-sized recording-paper sheet 35a or the calibration sheet 90. Additionally, the changeover controller 95 tracks the position of the sheet. It is possible to easily track the sheet position on the basis of carrying-speed information of the sheet carried on the main passage 24. In the case the normal-sized recording-paper sheet 35 is carried to the changing guide 85, the changeover controller 95 activates the solenoid 87 to switch the sheet passage to the main passage 24. By contrast, in the case the large-sized recording-paper sheet 35a or the calibration sheet 90 is carried, the changeover controller 95 switches the sheet passage to the sub-passage 61.

The calibration controller 96 controls the feeding section 17 and the exposing section 20 to form the calibration sheet 90 upon setting the magazines 27a and 27b. Additionally, the calibration controller 96 calibrates recording density of the exposure section 20 on the basis of a measurement density value of the respective density patterns 93a of the calibration pattern 93. The measurement density value is calculated from the image data transferred from the density measuring sensor 94.

Upon setting the magazines 27a and 27b to predetermined positions of the feeding section 17, the bar-code readers 30a and 30b read magazine ID information recorded in the bar codes 29a and 29b. The read magazine ID information is sent to the calibration controller 96 of the controller 15. At this time, the calibration controller 96 judges whether or not the magazine ID of the newly loaded magazine 27a (27b) coincides with the magazine ID of the previous magazine 27a (27b). When the magazine IDs coincide, the kind (thickness and material) of the photosensitive recording paper 25 (recording-paper roller 26) contained in the magazine 27a (27b) is identical with that of the previous one. Thus, the calibration controller 96 does not perform the calibration. In virtue of this, loss of the photosensitive recording paper 25 may be reduced.

When the magazine IDs do not coincide, the calibration controller 96 draws the photosensitive recording paper 25 from the magazine 27a (27b), which is loaded in the feeing section 17, by a predetermined length. Further, the calibration controller 96 actuates the cutter 30a (30b) to form the recording-paper sheet 35. The formed sheet 35 is carried to the exposing section 20 through the back-printing section 18 and the skew-correcting section 19, and then, the prescribed calibration pattern 93 is recorded (by exposure). The recording-paper sheet 35, on which the calibration pattern 93 has been recorded, passes through the receiving section 21, the sorting section 22 and the discharging section 23, and is carried to the processor 14. For the recording-paper sheet 35 forwarded to the processor 14, the respective processes of developing, fixing, washing and drying are performed in the processing section 46 and the drying section 47 to form the calibration sheet 90. This calibration sheet 90 is sent to the passage switching section 48, and is carried along the sub-passage 61 to pass the density measuring sensor 94 such as described above.

When the calibration sheet 90 passes the density measuring sensor 94, the calibration pattern 93 is detected. On the basis of the image data of the detected calibration pattern 93, the measurement density values of the respective density patterns 93a of the calibration pattern 93 are calculated by an arithmetic processing section, which is not shown, and is stored in the density-data memory 97. The calibration controller 96 calculates a difference between the measurement density value of each density pattern 93a and the reference density value of each density pattern 93a stored beforehand in the reference-density memory 98. Incidentally, the reference density value is the value known by measuring the density of the calibration pattern 93 (the respective density patterns 93a) recorded in the exposing section 20 of which the recording density is properly calibrated.

On the basis of a calculation result of the difference, the calibration controller 96 evaluates a correction value for correcting the recording density of the exposing section 20 (exposing unit 41), namely for correcting a radiation amount or a radiation period of the recording light to be radiated at the time of exposure. The correction value is stored in the correction-parameter memory 99 so as to relate to the respective magazines 27a and 27b. When the magazine IDs of the loaded magazines 27a and 27b have changed, the newly calculated correction value is overwritten in the correction-parameter memory 99. The exposing section 20 corrects the radiation amount or the radiation period on the basis of the correction value of the respective magazines 27a and 27b stored in the correction-parameter memory 99. In virtue of this, the photographic print having proper density is obtained.

The correction value may be obtained from a data table formed and memorized beforehand. In the data table, the difference between the measurement density value and the reference density value is related to the correction value. Moreover, in the data table, the difference and the correction value are further related to temperature and humidity of the periphery or the interior of the image recording apparatus 10. In this case, a temperature sensor and a humidity sensor are provided at the periphery or the interior of the image recording apparatus 10. Meanwhile, when the recording density is calibrated, a correction amount for correcting the density in the image processor 12 may be altered instead of correcting the radiation amount or the radiation period of the recording light.

In this embodiment, it is possible not only to automatically commence the calibration of the recording density at the time of setting of the magazines 27a and 27b but also to manually commence the calibration by a clerk (operator). In other words, the image recording apparatus 10 has an “automatic mode” for automatically commencing the calibration of the recording density, and a “manual mode” for manually commencing the calibration of the recording density. These modes are changed by operating a mode changing lever 102 of the operation panel 100.

When the automatic mode is selected by the mode changing lever 102, the calibration of the recording density is commenced at the time of setting of the magazines 27a and 27b along the above-described sequence. When the manual mode is selected, the calibration of the recording density is commenced only after the commencement of the calibration has been instructed by the clerk (operator) via the operation panel 100. Under the manual mode, the clerk (operator) is required to perform the commencing operation of the calibration of the recording density on the operation panel 100. However, since the unnecessary calibration is not carried out, the loss of the photosensitive recording paper 25 may be reduced. When the image recoding apparatus 10 is placed in a convenience store, a department store and so forth, the automatic mode is selected since the exclusive clerk does not exist. When the image recoding apparatus 10 is placed in a photo studio employing the exclusive clerk, the manual mode is selected in accordance with situation.

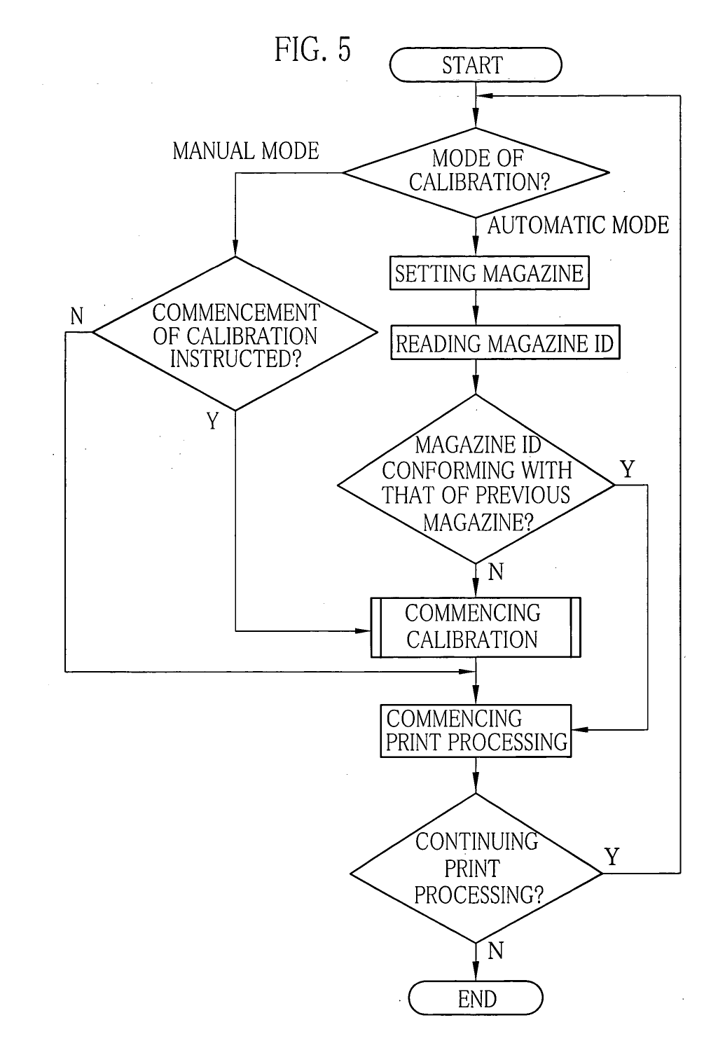

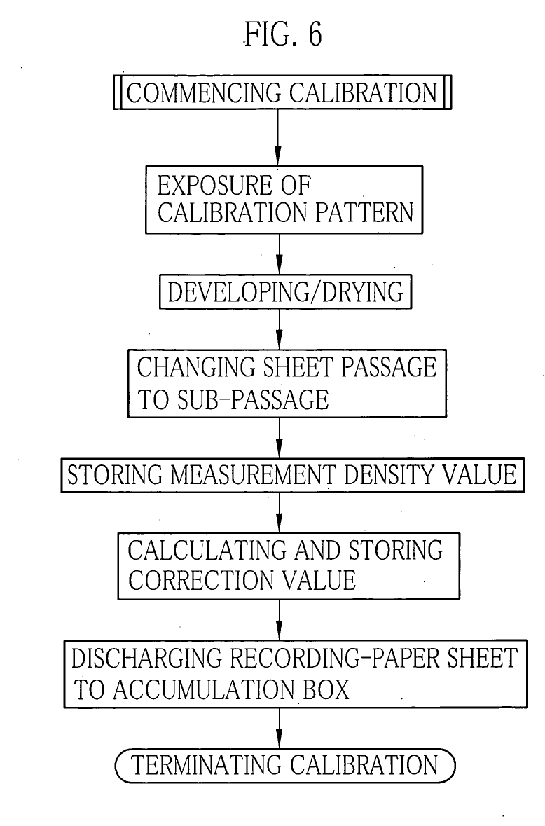

Next, with respect to the image recording apparatus 10 having the above structure, the sequence for commencing the calibration of the recording density of the exposing section 20 is described below with flowcharts shown in FIGS. 5 and 6. When the manual mode is selected as the calibration mode, the calibration is not commenced until the calibration-commencing operation for the recording density is performed on the operation panel 100. Until then, the image recording apparatus 10 is kept in a standby state or produces the photographic print (performs print processing) on the basis of the image data inputted into the image input device 12 (see FIG. 1).

When the automatic mode is selected as the calibration mode, the magazine ID information recorded in the bar code 29a (29b) of the magazine 27a (27b) is read out by the bar-code reader 30a (30b) of the feeding section 17 upon setting the magazine 27a (27b) in the feeding section 17. The read magazine ID information is sent to the calibration controller 96 of the controller 15.

The calibration controller 96 judges whether or not the magazine ID of the newly loaded magazine 27a (27b) coincides with the magazine ID of the previously set magazine 27a (27b). At this time, when the magazine IDs coincide with each other, the kinds of the contained photosensitive recording papers 25 (recording-paper rolls 26) are identical. Accordingly, the calibration controller 96 does not perform the calibration such as described above. When the magazine IDs do not coincide, the calibration controller 96 commences the calibration of the recording density of the exposing section 20 along the flowchart shown in FIG. 6.

The calibration controller 96 draws photosensitive recording paper 25 by the predetermined length from the magazine 27a (27b) loaded in the feeding section 17. Additionally, the calibration controller 96 actuates the cutter 30a (30b) to form the recording-paper sheet 35. The formed recording-paper sheet 35 is carried to the exposing section 20 through the back-printing section 18 and the skew-correcting section 19 to record the prescribed calibration pattern 93. The recording-paper sheet 35 on which the calibration pattern has been recorded passes the receiving section 21, the sorting section 22 and the discharging section 23. After that, the respective processes of developing, fixing and drying are performed in the processing section 46 and the drying section 47, and then, the recording-paper sheet 35 becomes the calibration sheet 90. This calibration sheet 90 is carried to the passage switching section 48 (see FIG. 1).

The calibration sheet 90 carried to the passage switching section 48 enters the body 48a thereof through the inlet 58 (see FIG. 2). The calibration sheet 90, which has entered the body 48a, is carried along the main passage 24 by the first and second carrying roller pairs 65 and 66. The changeover controller 95 (see FIG. 3) of the controller 15 judges that the carried sheet is the calibration sheet 90, on the basis of the sheet information stored in the sheet-information memory 92. At the same time, the changeover controller 95 tracks the position of the calibration sheet 90. And then, the changeover controller 95 actuates the solenoid 87 (the passage switching mechanism 84) to change the sheet passage to the sub-passage 61 when the calibration sheet 90 is just carried to the changing guide 85. Thus, the calibration sheet 90 is carried along the sub-passage 61 toward the sub-outlet 60.

The calibration sheet 90 passes the changing guide 85 and is carried along the sub-passage 61 toward the sub-outlet 60 by the fourth to sixth carrying roller pairs 73 to 75. On the way to the sub-outlet 60, the calibration sheet 90 passes the above-described density measuring sensor 94. At this time, on the basis of the image data obtained by the density measuring sensor 94, the measurement density values of the respective density patterns 93a of the calibration pattern 93 are calculated in the arithmetic processing section not shown. The calculated measurement density value is stored in the density-data memory 97 of the controller 15.

The calibration controller 96 calculates the difference between the measurement density value of each density pattern 93a, which is stored in the density-data memory 97, and the reference density value of each density pattern 93a stored beforehand in the reference-density memory 98. On the basis of the calculation result of the difference, the calibration controller 96 evaluates the correction value for correcting the radiation amount or the radiation period of the recording light to be applied at the time of exposure. The correction value is stored in the correction-parameter memory 99 so as to relate to the respective magazines 27a and 27b. Meanwhile, the calibration sheet 90 having passed the density measuring sensor 94 is discharged from the sub-outlet 60 to the accumulation box 57, and the calibration is completed. Incidentally, the calibration sheets 90 piled up in the accumulation box 57 may be periodically got rid of, for example every week.

After the calibration, the controller 15 draws the photosensitive recording paper 25 from the magazine 27a (27b) by the predetermined length. In addition, the controller 15 actuates the cutter 30a (30b) to form the recording-paper sheet 35. And then, the controller 15 commences producing the photographic print (performing the print processing) on the basis of the image data inputted into the image input device 12. At this time, the exposing section 20 corrects the radiation amount or the radiation period of the recording light on the basis of the correction value of the respective magazines 27a and 27b stored in the correction-parameter memory 99. Thus, the photographic print having proper density is obtained. When the magazine 27a (27b) has been newly set after repetition of the print processing, the above-described sequence is repeated.

In the case that the two magazines 27a and 27b are set in the feed section 17 such as described in this embodiment, it is usual to exchange one of the magazines 27a and 27b while the recording-paper sheet 35 is fed from the other magazine onto the main passage 24. In this case, the recording-paper sheet 35 of the calibration sheet 90 fed from the magazine 27b is wedged into the recording-paper sheets 35 of the photographic prints continuously fed from the magazine 27a. It is preferable to carry the calibration sheet 90 and the recording-paper sheet 35 of the photographic print in a state separating by a predetermined interval so that the sheet passage is easily switched.

In the passage switching section 48, the sheet passage is changed from the main passage 24 to the sub-passage 61 on the basis of the detection result of the changeover controller 95 only when the calibration sheet 90 is carried. Thus, the calibration sheet 90 is prevented from being interposed between the photographic prints. The correction value of the magazine 27b evaluated on the basis of the detection result of the density measuring sensor 94 is stored in the correction-parameter memory 99. In consequence, it is possible to perform print processing by successively feeding the recording-paper sheet 35 from the magazine 27b after completion of feeding from the magazine 27a.

As described above, the sub-passage 61 diverges from the main passage 24. The passage switching mechanism 84 switches the sheet passage between the main passage 24 and the sub-passage 61 to discharge the calibration sheet 90, which is unnecessary for the product, from the sub-outlet 60. Thus, it is possible to prevent the calibration sheet 90 from being interposed between the photographic prints. Moreover, it is possible to reduce operational labor of the clerk (operator), since it is unnecessary to remove the calibration sheet 90 whenever the calibration is performed. Further, it is possible to successively commence the print processing after the calibration. In the result, it is possible to automatically and successively perform the calibration and the print processing in an unmanned state.

When the new magazines 27a and 27b have just been set in the feeding section 17, the calibration is automatically performed so that it is unnecessary to manually commence the calibration by the clerk and the operator. Thus, the image recording apparatus 10 may be placed without problems in a convenience store, a department store, a station and so forth, where an exclusive person for managing this apparatus 10 does not exist.

In this embodiment, the calibration is automatically commenced when the magazine 27a (27b) has just been set in the feeding section 17. The present invention, however, is not limited to this. For instance, the calibration may be commenced when an electric source of the image recording apparatus 10 has just been turned on. Moreover, the calibration may be commenced at a predetermined time.

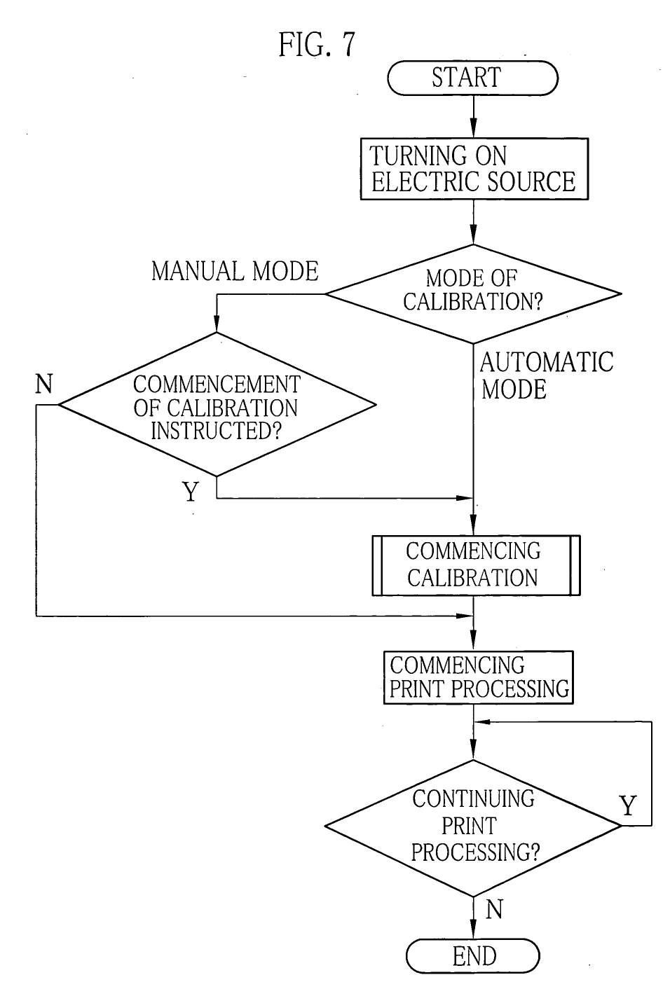

With a flowchart shown in FIG. 7, is described below a case in that the calibration is commenced upon turning on the electric source of the image recording apparatus 10. As shown in FIG. 7, when the automatic mode is selected as the calibration mode, the calibration is commenced by the calibration controller 96 upon turning on the electric source of the image recording apparatus 10. Description concerning a sequence to be performed after the commencement of the calibration is abbreviated, since detail of this sequence is identical with that described in FIGS. 5 and 6. Also, when the manual mode is selected as the calibration mode, description concerning this mode is abbreviated, since detail thereof is identical with that described in FIGS. 5 and 6. In the case the image recording apparatus 10 is placed in the photo studio and so forth, it is usual that the electric source is turned off during nighttime hours and on holidays. It is possible to perform the calibration at least one time per business day by using this method.

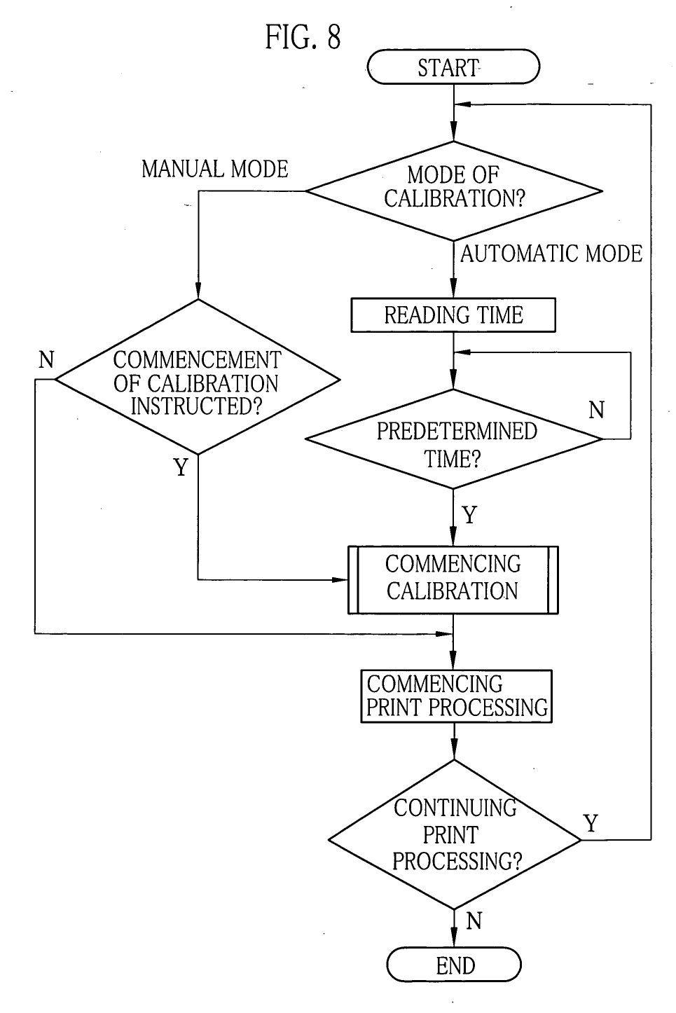

Next, with a flowchart shown in FIG. 8, is described below a case in that the calibration is commenced at the predetermined time. In this case, the time for commencing the calibration is preset and is stored beforehand in any memory of the controller. As to the time for commencing the calibration, it is preferable to set it within hours during which a print-processing amount is small. As shown in FIG. 8, in the case the automatic mode is selected as the calibration mode, the calibration controller 95 commences the calibration when the current time outputted from a time circuit, which is not shown, has reached the predetermined time. Description concerning a sequence to be performed after the commencement of the calibration is abbreviated, since detail of this sequence is identical with that described in FIGS. 5 and 6. Also, when the manual mode is selected as the calibration mode, description of this mode is abbreviated, since detail thereof is identical with that described in FIGS. 5 and 6. When the image recording apparatus 10 is placed in the convenience store and so forth, it is usual that the electric source thereof is turned on most of the day. It is possible to perform the calibration at least one time per day by using this method.

The conditions for commencing the calibration may be combined and the calibration may be commenced when at least one of the conditions is satisfied. For instance, the calibration may be commenced at least one of when the magazine 27a (27b) has just been set, when the electric source has just been turned on, and when the predetermined time has arrived. In this case, it is possible to calibrate the recording density of the exposing section 20 more accurately.

In the present invention, the calibration sheet 90 is discharged from the sub-outlet 60 as in the case of the large-sized recording-paper sheet 35a. The present invention, however, is not limited to this. Another sheet (photosensitive recording paper 25) unnecessary for the product, which is not shown, may be discharged from the sub-outlet 61. This unnecessary sheet is, for example, a joint portion of the photosensitive recording paper 25 (splice sheet), which is cut by the respective cutters 30a and 30b when the recording-paper sheet 25 is formed. Besides this, the unnecessary sheet may be an anterior end of the photosensitive recording paper 25 (fogging sheet), which is similarly cut when the recording paper 25 is drawn from the recording-paper roll 26. Also in this case, the changeover controller 95 tracks positions of the splice sheet and the fogging sheet on the basis of the sheet information stored in the sheet-information memory 92. In virtue of this, the sheet passage is changed to the sub-passage 61 when these sheets have just been sent to the changing guide 85.

Moreover, in the present invention, the kind of the sheet fed from the feeding section 17 is judged on the basis of the sheet information. The present invention, however, is not limited to this. For instance, a sheet judging sensor may be disposed at an upstream side of the changing guide 85 in the carrying direction to judge the kind of the sheet on the basis of a detection signal outputted from this sensor. The sheet judging sensor is a color CCD image sensor and so forth.

When printing is performed for large-sized sheets, large-sized photographic prints are accumulated in the accumulation box 57 used for the unnecessary sheet. In view of this, it is preferable that selecting the large-sized print is adapted to be impossible in automatic printing to be performed at the convenience store and so forth. Instead of restricting the print, a changing (breaching) guide (not shown) may be provided at the sub-outlet 60, through which the unnecessary sheet is discharged, so as to discharge only the large-sized prints onto the top of the accumulation box 57. Further, instead of the accumulation box 57, an open-type tray may be employed.

In the present invention, the density measuring sensor 94 is disposed at the sub-passage 61. The present invention, however, is not limited to this. The density measuring sensor 94 may be disposed between the drying section 47 and the passage switching mechanism 84.

In the present invention, the photosensitive recording paper 25 is contained in the respective magazines 27a and 27b as the recording-paper roll 26 in which the recording paper 25 is taken up in the roll form. The present invention, however, is not limited to this. The photosensitive recording paper 25 cut in a predetermined size may be contained.

Moreover, the present invention is not limited to the image recording apparatus for producing the photographic print, and may be applicable to various printers of a thermal printer, a thermal-transfer printer, an ink-jet printer and so forth for recording an image on a sheet-shaped recording material.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. An image recording apparatus comprising:
an image recorder for recording an image on a sheet-shaped recording material;
a magazine for containing said recording material to be fed to said image recorder;
a discharger for discharging said recording material to be treated as a product on which said image is recorded;
a main outlet formed in said discharger;
a main passage extending from said magazine to said main outlet;
a sub-outlet for discharging the unnecessary recording material prohibited from being treated as said product;
a sub-passage diverging from said main passage toward said sub-outlet;
a passage switching mechanism disposed at a bifurcation of said main passage and said sub-passage, said passage switching mechanism being changeable between a first state in that said recording material is carried along said main passage, and a second state in that said recording material is carried along said sub-passage; and
a changeover controller for judging whether said recording material is necessary or not, said changeover controller changing said passage switching mechanism from said first state to said second state when the unnecessary recording material passes said bifurcation.

2. An image recording apparatus according to claim 1, wherein said recording materials having at least a normal size and a larger size are fed to said image recorder and said changeover controller judges whether said recording material has said larger size or not, said changeover controller changing said passage switching mechanism from said first state to said second state when said recording material of said larger size passes said bifurcation.

3. An image recording apparatus according to claim 1, wherein an accumulation member for accumulating the unnecessary recording materials is disposed at a downstream side of said sub-outlet in a carrying direction.

4. An image recording apparatus according to claim 1, further comprising:
a density measuring unit disposed at said sub-passage to measure a density of the image recorded on said recording material; and
a calibration controller for feeding said recording material from said magazine to said image recorder to record a calibration pattern, which is used for calibrating a recording density of said image recorder, on said recording material, said calibration controller calculating a difference between a measured density of the calibration pattern obtained by said density measuring unit, and a known reference density to perform calibration of said recording density on the basis of a calculation result of said difference,
wherein said unnecessary recording material is said recording material on which said calibration pattern is recorded.

5. An image recording apparatus according to claim 4, wherein said calibration is automatically commenced under an automatic mode, and is manually commenced under a manual mode.

6. An image recording apparatus according to claim 5, wherein said calibration controller commences said calibration of said recording density under said automatic mode on satisfying at least one of conditions that said magazine has just been loaded in an apparatus body, that an electric source of said apparatus body has just been turned on, and that a predetermined time has just arrived.

7. An image recording apparatus according to claim 6, further comprising:
a record member attached to said magazine, said record member storing identification information of said magazine including at least kind information of said recording material; and
a reader for reading said identification information stored in said record member, said reader being fixed to said apparatus body,
wherein said calibration controller avoids performing said calibration of said recording density when said magazine has just been loaded under said automatic mode, in a case that said identification information read by said reader is identical with the identification information of the previously loaded magazine.

8. An image recording apparatus according to claim 7, wherein said identification information is represented by a bar code and said reader reads said bar code.

9. An image recording apparatus according to claim 4, wherein said density measuring unit is a color CCD image sensor.

10. An image recording apparatus according to claim 1, wherein said recoding material contained in said magazine is a recording-paper roll in which joined recording papers are taken up in a roll form.

11. An image recording apparatus according to claim 10, further comprising:
a cutter for cutting said recoding paper, which is drawn out of said recording-paper roll, into a predetermined length,
wherein said unnecessary recording material is at least one of a joint portion of said recording paper cut by said cutter, and a leading portion of said recording paper cut by said cutter.

12. An image recording apparatus according to claim 1, wherein said passage switching mechanism comprises:
a rotatable changing guide disposed at said bifurcation of said main passage and said sub-passage; and
a rotating member for rotating said changing guide, said changeover controller actuating said rotating member to rotate said changing guide for switching said first and second states of said passage switching mechanism.

13. An image recording apparatus according to claim 12, wherein said rotating member comprises:
an arm of which one end is fixed to said changing guide; and
a solenoid connected to the other end of said arm, said changeover controller actuating said solenoid to rotate said changing guide via said arm.

14. An image recording apparatus according to claim 13, wherein said changing guide has a first guide surface and a second guide surface, said first guide surface constituting a part of said main passage and said second guide surface constituting a part of said sub-passage.

15. An image recording apparatus according to claim 14, wherein said changing guide is made of plastic.
